(19) United States
(12) Patent Application Publication
(10) Pub. No.: US 2011/0070866 A1
(43) Pub. Date: Mar. 24, 2011

(54) SYSTEM AND METHOD FOR REMOTE ADMINISTRATION OF A MOBILE PHONE

(75) Inventor: CHIA-CHUN CHIEN, Tu-Cheng (TW)

(73) Assignee: HON HAI PRECISION INDUSTRY CO., LTD., Tu-Cheng (TW)

(21) Appl. No.: 12/697,355

(22) Filed: Feb. 1, 2010

(30) Foreign Application Priority Data
Sep. 18, 2009 (CN) 200910307271.0

(51) Int. Cl. H04M 3/00; H04M 1/66; G06F 15/16

(52) U.S. Cl. 455/411; 455/419; 709/206

(57) ABSTRACT

A system and method for remote administration of a mobile phone includes a administrating terminal, and a transmitting device connected to the administrating terminal. The administrating terminal reads an identification number and a phone number of the mobile phone, sets functions of the mobile phone to be administrated, and generates a control command. The transmitting device wirelessly transmits the control command to the mobile phone according to the phone number, receives a acknowledgement from the mobile phone when the identification number of the control command matches an IMEI code of the mobile phone, and transmits the acknowledgement to the administrating terminal. The administrating terminal remotely administrates the mobile phone according to the control command.

### BACKGROUND

1. Technical Field

Embodiments of the present disclosure generally relate to remote administration systems and methods, and more particularly to a system and method for remote administration of a mobile phone.

2. Description of Related Art

Companies may forbid to have their employees have mobile phones that have a camera, a video camera, BLUETOOTH connectivity, or other recording or transmission mechanism, so as to protect company trade secrets. However, most mobile phones nowadays may have multiple functions, thus creating a problem in the workplace.

What is needed, therefore, is an improved method to overcome the limitations described.

### BRIEF DESCRIPTION OF THE DRAWINGS

FIG. 1 is a block diagram of one embodiment of a system for remote administration of a mobile phone.

FIG. 2 is a block diagram of one embodiment of function modules of an administrating unit included in the system of FIG. 1.

FIG. 3 is a block diagram of one embodiment of function modules of a command executing unit included in the system of FIG. 1.

FIG. 4 is a flowchart illustrating one embodiment of a method for remote administration of a mobile phone.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

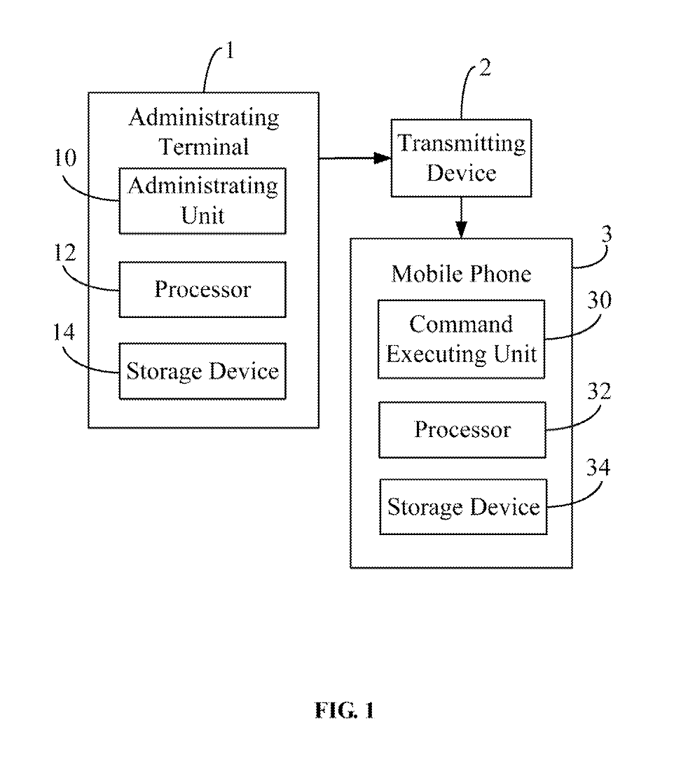

FIG. 1 is a block diagram of one embodiment of a system for remote administration of a mobile phone 3. In the embodiment, the mobile phone 3 is connected to a administrating terminal 1 via a transmitting device 2. The administrating terminal 1 connects to the transmitting device 2 via a network, and the transmitting device 2 wirelessly communicates with the mobile phone 3. The transmitting device 2 may be a server, or a transmitter that connects with a base station. In the embodiment, the administrating terminal 1 comprises an administrating unit 10, which generates a control command for administration of the mobile phone 3, and transmission of the control command to the mobile phone 3 via the transmitting device 2. The mobile phone 3 comprises a command executing unit 30, which executes the control command by administration of the mobile phone 3. Administration of the mobile phone 3 may include setting various functions, such as disabling/restricting an e-mail function, closing a camera/image capturing function, closing a video camera, closing BLUETOOTH connectivity, closing a recording function, or deleting short messages of the mobile phone 3, for example.

In the embodiment, the administrating terminal 10 further includes at least one processor 12, and a storage device 14. The at least one processor 12 is operable to execute one or more computerized operations of the administrating unit 10 that may be stored in the storage device 14. The mobile phone 3 further includes at least one processor 32, and a storage device 34. The at least one processor 32 is operable to execute one or more computerized operations of the command executing unit 30 that may be stored in the storage device 34. The storage device 14 and 34 may be a hard disk drive, a compact disc, a digital video disc, or a tape drive.

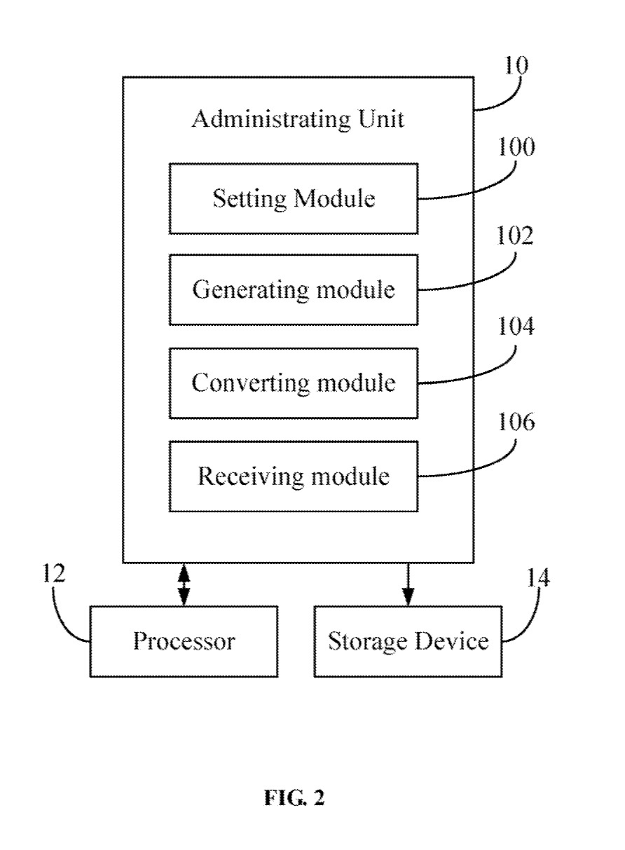

FIG. 2 is a block diagram of one embodiment of function modules of the administrating unit 10. The administrating unit 10 may include a plurality of instructions executable by the at least one processor 12. In one embodiment, the administrating unit 10 may include a setting module 100, a generating module 102, a converting module 104, and a receiving module 106.

The setting module 100 is operable to read an identification number and a phone number of the mobile phone 3 and set functions of the mobile phone 3 to be administrated. In the embodiment, the identification number may be the international mobile equipment identity (IMEI) code of the mobile phone 3. The functions may be an e-mail function, a camera/image capturing function, BLUETOOTH connectivity, a recording function, and a short message transmitting function of the mobile phone 3, for example.

The generating module 102 is operable to generate a control command for remote administration of the mobile phone 3 according to the set functions and the identification number.

The converting module 104 is operable to convert the control command into an executable command executable by the mobile phone 3, and send the executable command to the transmitting device 2 via the network. For example, if the control command is saved in an extensible markup language (XML) file, the converting module 104 needs to convert the XML file into a wireless binary XML (WBXML) file, which can be executed by the mobile phone 3. In the embodiment, the transmitting device 2 may be a wireless router.

The transmitting device 2 receives the executable command, and wirelessly transmits the executable command to the mobile phone 3 according the phone number of the mobile phone 3.

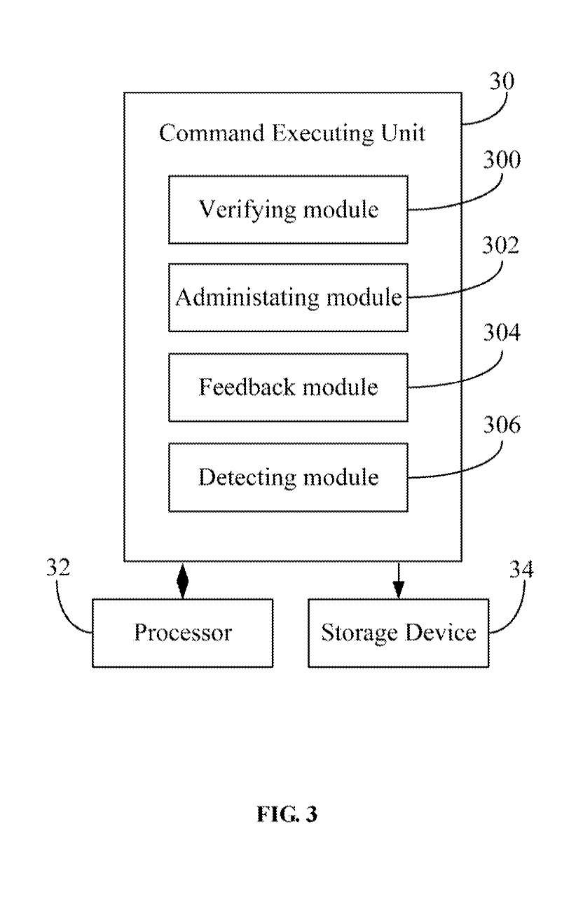

FIG. 3 is a block diagram of one embodiment of function modules of the command executing unit 30. The command executing unit 30 may include a plurality of instructions executable by the at least one processor 32. In one embodiment, the command executing unit 30 may include a verifying module 300, a administrating module 302, a feedback module 304, and a detecting module 306.

The verifying module 300 is operable to receive the executable command, verify whether the identification number included in the executable command matches the IMEI code of the mobile phone 3. Each mobile phone 3 has only one IMEI code, which is an unique identifier of the mobile phone 3.

If the identification number included in the executable command matches the IMEI code of the mobile phone 3, the administrating module 302 executes the executable command by administration of the mobile phone 3 according to the executable command, such as disabling/restricting the e-mail function, closing the camera/image capturing function, closing the video camera, closing the BLUETOOTH connectivity, closing the recording function, or deleting short messages of the mobile phone 3, for example. The feedback module 304 returns an acknowledgement to the administrating terminal 1 via the transmitting device 2 to indicate that the control command is valid, for example, the acknowledgement may be described as “the identification number is valid.”

If the identification number of the executable command does not match the IMEI code of the mobile phone 3, the feedback module 304 is further operable to return a acknowledgement to the administrating terminal 1 to indicate that the control command is invalid, for example, the acknowledgement is described as “the identification number is invalid.”

In the embodiment, the receiving module 106 receives the acknowledgement from the mobile phone 3. If no acknowledgement is received from the mobile phone 3 with a predetermined time period, the receiving module 106 is further operable to display a dialog box indicating that the administrating terminal 1 administrates the mobile phone 3 unsuccessfully. In one embodiment, the predetermined time period may be thirty seconds, or one minute, for example.

The detecting module 306 is operable to detect whether the mobile phone 3 uses a new phone number when the mobile phone 3 is started, and updates the new phone number to the administrating terminal 1 upon a condition that a new phone number is used. For example, the mobile phone 3 uses a phone number “a” before, and uses a phone number “b” at this point. The phone number “b” is different from the phone number “a.” In the embodiment, the phone number is stored in the storage device 34 and the storage device 14.

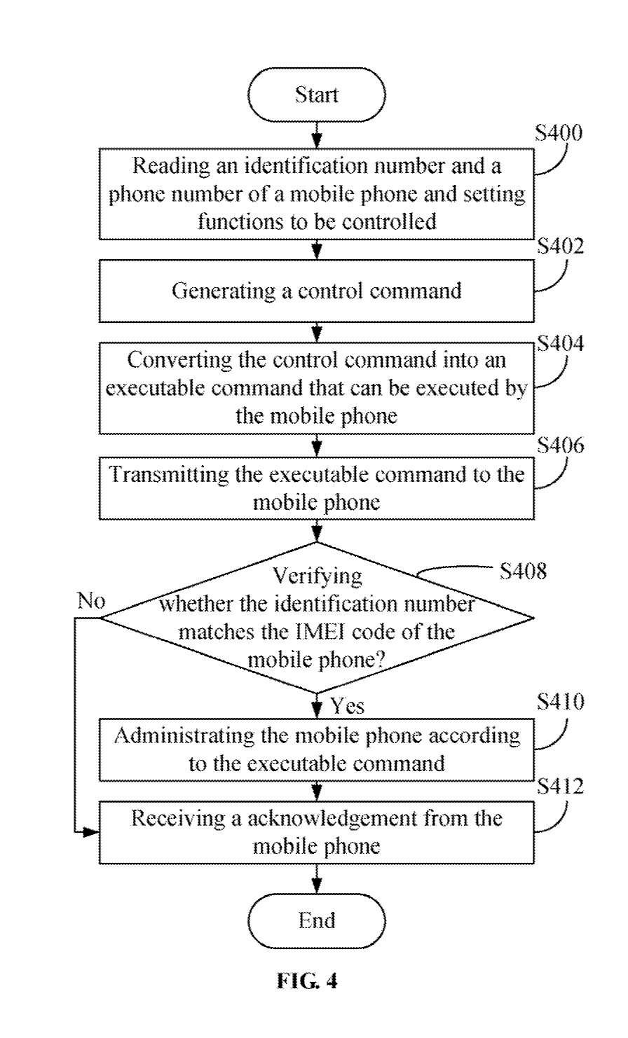

FIG. 4 is a flowchart illustrating one embodiment of a method for remote administration of the mobile phone 3 by utilizing the administrating unit 10 and the command executing unit 30.

In block S400, the setting module 100 reads an identification number and a phone number of the mobile phone 3, and sets functions of the mobile phone 3 to be administrated. In the embodiment, the phone number stored in the storage device 34.

In block S402, the generating module 102 generates a control command for disabling/restricting the functions of the mobile phone 3 according to the set functions and the identification number.

In block S404, the converting module 104 converts the control command into an executable command executable by the mobile phone 3. For example, if the control command is saved in an XML file, the converting module 104 needs to convert the XML file into a WBXML file, which can be executed by the mobile phone 3.

In block S406, the converting module 104 transmits the executable command to the mobile phone 3 according to the phone number via the transmitting device 2. In the embodiment, the transmitting device 2 may be a server, or a transmitter that connects with a base station, and wirelessly transmits the executable command to the mobile phone 3.

In block S408, the verifying module 300 verifies whether the identification number of the executable command matches the IMEI code of the mobile phone 3. If the identification number matches the IMEI code of the mobile phone 3, the flow enters into block S410. Otherwise, if the identification number does not match the IMEI code, i.e., the control terminal 1 sends a invalid command to the mobile phone 3, the flow enters into block S412.

In block S410, the administrating module 302 executes the executable command by administration of the mobile phone 3, such as disabling/restricting the e-mail function, closing the camera/image capturing function, closing the video camera, closing the BLUETOOTH connectivity, closing the recording function, or deleting short messages of the mobile phone 3, for example. Through above process, the administrating terminal 1 can remotely administrate the mobile phone 3.

In block S412, the receiving module 106 receives a acknowledgement returned from the feedback module 304. In the embodiment, the acknowledgement is used for indicating whether the control command is valid. For example, if the identification number matches the IMEI code of the mobile phone 3, the acknowledgement indicates that the control command is valid. For another example, if the identification number does not match the IMEI code of the mobile phone 3, the acknowledgement indicates that the control command is invalid.

In one embodiment, if no acknowledgement is received from the mobile phone 3 in a predetermined time period, the receiving module 106 displays a dialog box indicating that the administrating terminal 1 administrates the mobile phone 3 unsuccessfully. When the mobile phone 3 is started, the detecting module 306 may detect whether a new phone number is used by the mobile phone 3. If a new phone number is used by the mobile phone 3, the detecting module 306 updates the phone number to the administrating terminal 1 and the storage device 304.

According to above method, the administrating terminal 1 can administrate one or more mobile phones simultaneously and remotely.

Although certain inventive embodiments of the present disclosure have been specifically described, the present disclosure is not to be construed as being limited thereto.

Various changes or modifications may be made to the present disclosure without departing from the scope and spirit of the present disclosure.

What is claimed is:

1. A computer-implemented method for remote administration of a mobile phone, the method comprising:
(a) reading an identification number and a phone number of the mobile phone, and setting functions of the mobile phone 3 to be administrated;
(b) generating a control command according to the set functions and the identification number;
(c) transmitting the control command to the mobile phone according to the phone number through a transmitting device; and
(d) administrating the mobile phone according to the control command.

2. The method as claimed in claim 1, before the block (c) further comprising:
converting the control command into an executable command executable by the mobile phone.

3. The method as claimed in claim 1, after the block (c) further comprising:
verifying whether the identification number matches an IMEI code of the mobile phone;
executing the block (d) and receiving a acknowledgement from the mobile phone to indicate that the control command is valid upon a condition that the identification number matches the IMEI code of the mobile phone; or
receiving a acknowledgement from the mobile phone to indicate that the control command is invalid upon a condition that the identification number does not match the IMEI code of the mobile phone.

4. The method as claimed in claim 3, after the block (c) further comprising:
displaying a dialog box indicating that the administrating terminal administrates the mobile phone unsuccessfully if no acknowledgement is received from the mobile phone in a predetermined time period.

5. The method as claimed in claim 1, further comprising:
detecting whether a new phone number is used by the mobile phone when the mobile phone is started; and
updating the phone number upon a condition that a new phone number is used.

6. The method as claimed in claim 1, wherein the functions comprise an e-mail function, a camera/image capturing function, BLUETOOTH connectivity, a recording function, and a short message transmitting function of the mobile phone.

7. A storage medium having stored thereon instructions that, when executed by a processor of a administrating terminal, cause the administrating terminal to perform a method for remote administration of a mobile phone, the method comprising:
(a) reading an identification number and a phone number of the mobile phone, and setting functions of the mobile phone 3 to be administrated;
(b) generating a control command according to the set functions and the identification number;
(c) transmitting the control command to the mobile phone according to the phone number through a transmitting device; and
(d) administrating the mobile phone according to the control command.

8. The storage medium as claimed in claim 7, wherein the method further comprises a block before the block (c):
converting the control command into an executable command executable by the mobile phone.

9. The storage medium as claimed in claim 7, wherein the method further comprises blocks after the block (c):
verifying whether the identification number matches an IMEI code of the mobile phone;
executing the block (d) and receiving a acknowledgement from the mobile phone to indicate that the control command is valid upon a condition that the identification number matches the IMEI code of the mobile phone; or
receiving a acknowledgement from the mobile phone to indicate that the control command is invalid upon a condition that the identification number does not match the IMEI code of the mobile phone.

10. The storage medium as claimed in claim 9, wherein the method further comprises:
displaying a dialog box indicating that the administrating terminal administrates the mobile phone unsuccessfully if no acknowledgement is received from the mobile phone in a predetermined time period.

11. The storage medium as claimed in claim 7, wherein the method further comprises:
detecting whether a new phone number is used by the mobile phone when the mobile phone is started; and
updating the phone number upon a condition that a new phone number is used.

12. The storage medium as claimed in claim 7, wherein the functions comprise an e-mail function, a camera/image capturing function, BLUETOOTH connectivity, a recording function, and a short message transmitting function of the mobile phone.

13. A system for remote administration of a mobile phone, the system comprising:
a administrating terminal operable to read an identification number and a phone number of the mobile phone, set functions of the mobile phone to be administrated, and generate a control command according to the set functions and the identification number; and
a transmitting device operable to receive the control command, wirelessly transmit the control command to the mobile phone according to the phone number, receive a acknowledgement from the mobile phone, and transmit the acknowledgement to the administrating terminal; and
the administrating terminal further operable to remotely administrate the mobile phone according to the control command.

14. The system as claimed in claim 13, wherein the administrating terminal comprises:
a setting module operable to read the identification number and the phone number of the mobile phone, and set the functions of the mobile phone to be administrated;
a generating module operable to generate the control command according to the set functions and the identification number; and
a converting module operable to convert the control command into an executable command executable by the mobile phone.

15. The system as claimed in claim 14, wherein the mobile phone comprises:
a verifying module operable to receive the control command, verify whether the identification number of the control command matches the IMEI code of the mobile phone;
a administrating module operable to execute the executable command by administration of the mobile phone if the identification number matches the IMEI code of the mobile phone; and
a acknowledgement module operable to return a acknowledgement to the administrating terminal via the transmitting device to indicate whether the control command is valid.

16. The system as claimed in claim 15, wherein the administrating terminal further comprises:
a receiving module operable to receive the acknowledgement from the mobile phone, and display a dialog box indicating that the administrating terminal administrates the mobile phone unsuccessfully if no acknowledgement is received from the mobile phone in a predetermined time period.

17. The system as claimed in claim 13, wherein the mobile phone further comprises:
a detecting module operable to detect whether a new phone number is used by the mobile phone when the mobile phone is started, and update the phone number upon a condition that a new phone number is used by the mobile phone.

18. The system as claimed in claim 13, wherein the transmitting device is a server, or a transmitter being connected with a base station.

19. The system as claimed in claim 13, wherein the functions comprise an e-mail function, a camera/image capturing function, BLUETOOTH connectivity, a recording function, and a short message transmitting function of the mobile phone.
